(19) United States
(12) Patent Application Publication
(10) Pub. No.: US 2014/0033976 A1
(43) Pub. Date: Feb. 6, 2014

(54) HEATING SYSTEM FOR A ROLL-TO-ROLL DEPOSITION SYSTEM

(71) Applicant: Piero Sferlazzo, Marblehead, MA (US)

(72) Inventor: Piero Sferlazzo, Marblehead, MA (US)

(21) Appl. No.: 13/566,162

(22) Filed: Aug. 3, 2012

(51) Int. Cl. H05B 3/02; B05C 9/14

(52) U.S. Cl. 118/620; 219/201

(57) ABSTRACT

Disclosed is a heating system for a roll-to-roll tape deposition system. The heating system includes a sacrificial tape that is transported through a deposition zone between a susceptor plate and a process tape. The sacrificial tape receives an accumulation of deposition material that otherwise may accumulate on the susceptor plate and reduce its efficiency and temperature uniformity. In some embodiments, the sacrificial tape is heated by passage of an electrical current, thereby allowing the sacrificial tape to replace the susceptor plate and separate heating elements used to heat the process tape. The sacrificial tape may be provided on a payout roll that passes through the deposition system to a takeup roll or in the form of a continuous loop of tape.

### FIELD OF THE INVENTION

The invention relates generally to tape and web deposition systems. More particularly, the invention relates to a system and method for heating a tape or web in a roll-to-roll deposition system.

### BACKGROUND OF THE INVENTION

Roll-to-roll tape deposition systems, such as web chemical vapor deposition (CVD) systems, can be used to deposit semiconductor, dielectric, metallic and other thin films onto a surface of a tape or web. Often the roll-to-roll web deposition system requires that the tape to be coated be heated to a high temperature during the deposition process. Radiant heater elements arranged alongside the tape path are used to heat the nearby tape to the desired process temperature. The deposition zone can be a harmful environment for the radiant heating elements therefore a susceptor plate is typically used to protect the radiant heating elements from the deposition zone. The susceptor plate enables a more uniform temperature distribution on the tape which is on the opposite side of the plate from the radiant heating elements.

In some applications the susceptor plate is not fully shadowed by the passing tape. Consequently, one or more regions of the susceptor plate are exposed in the deposition zone. For example, multiple narrow tape strips that are separated and parallel to each other may pass under the deposition head. Consequently, a thick film may be deposited on regions of the susceptor plate corresponding to the gaps between the tape strips.

Problems can arise due to the unwanted deposition of material on the susceptor plate. For example, the deposited material can cause the emissivity of the susceptor plate to vary over time and therefore the temperature in the region of the nearby tape path can change over time even though the power supplied to the radiant heating elements is maintained constant. The temperature can be stabilized, for example, by using a temperature control feedback system based on the temperature sensed at one or more locations on or near the surface of the susceptor plate. Temperature stabilization does not address the need to clean accumulated deposits of material from the susceptor plate. The accumulated material may be sufficiently thick so that cracking occurs. Flakes and particles generated by this process can degrade the quality of the processed tape. In many applications the susceptor plate requires frequent maintenance to remove the accumulated material and limit the risk to the processed tape.

### SUMMARY OF THE INVENTION

In one aspect, the invention features a heating system for a roll-to-roll tape deposition system. The heating system includes a sacrificial tape comprising an electrically-conductive material, a tape transport system to transport the sacrificial tape along a tape path and a pair of coupling elements each comprising an electrically-conductive material and being in contact with the sacrificial tape at a position along the tape path. The heating system also includes an electrical power source in electrical communication with the coupling elements. An electrical current flowing through the sacrificial tape between the coupling elements increases a temperature of the sacrificial tape.

In another aspect, the invention features a heating system for a roll-to-roll tape deposition system. The heating system includes a sacrificial tape comprising a material that adheres to a deposition material, a tape transport system comprising a pair of tape guides that define a sacrificial tape path through a deposition zone and at least one heating element disposed along one side of the sacrificial tape path. The heating system also includes a susceptor plate disposed between the at least one heating element and the one side of the sacrificial tape path.

In yet another aspect, the invention features a roll-to-roll tape deposition system that includes a deposition head, a sacrificial tape comprising an electrically-conductive material, a sacrificial tape transport system, a pair of electrically-conductive rollers, an electrical power source and a process tape transport system. The deposition head is configured to deposit a material on a process tape in a deposition zone. The sacrificial tape transport system is in mechanical engagement with the sacrificial tape and is configured to transport the sacrificial tape along a tape path that passes through the deposition zone. Each of the electrically-conductive rollers is in contact with the sacrificial tape at a position along the sacrificial tape path so that at least a portion of the sacrificial tape path between the electrically-conductive rollers is in the deposition zone. The electrical power source is in electrical communication with the coupling elements so that an electrical current flowing through the sacrificial tape between the coupling elements increases a temperature of the sacrificial tape. The process tape transport system transports a process tape along a process tape path that passes through the deposition zone between the deposition head and the sacrificial tape path so that the sacrificial tape heats the process tape passing through the deposition zone.

In still another aspect, the invention features a method for heating a process tape in a roll-to-roll deposition system. A sacrificial tape is transported along a sacrificial tape path that passes through a deposition zone. A process tape is transported along a process tape path that passes through the deposition zone wherein the process tape path within the deposition zone passes between a deposition head and the sacrificial tape path. An electrical current is conducted through at least a portion of the sacrificial tape that is in the deposition zone to thereby heat the sacrificial tape and wherein the process tape in the deposition zone is heated by the sacrificial tape.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 illustrates a roll-to-roll deposition system 10 constructed according to a conventional architecture.

FIG. 2 is a top down view from underneath a deposition head showing how parallel narrow strips of process tape expose a susceptor plate to deposition material during a process run.

FIG. 3 illustrates a roll-to-roll tape deposition system having a heating system according to an embodiment of the invention.

FIG. 4 illustrates a roll-to-roll tape deposition system having a heating system according to another embodiment of the invention.

FIG. 5A and FIG. 5B are illustrations for a perspective view and a cross-sectional view, respectively, of an assembly having an electrically-conductive roller according to an embodiment of the invention.

FIG. 6 illustrates a roll-to-roll deposition system having a heating system according to another embodiment of the invention.

FIG. 7 illustrates a roll-to-roll deposition system having another embodiment of a heating system according to the invention.

### DETAILED DESCRIPTION

The systems and methods of the present invention may include any of the described embodiments or combinations of the described embodiments in an operable manner. Moreover, the steps of the methods of the present invention can be performed in any order with operable results and two or more steps can be performed simultaneously unless otherwise noted.

As used herein, the term “tape” means any tape, web, film, foil or other flexible material that is suitable as a substrate for receiving a deposited material in a deposition system. The term “process tape” refers to any tape, web, film, foil or other flexible material that is intended to receive a coating or film deposited by a deposition system, or which has received the deposition coating or film. The term “sacrificial tape” refers to any tape, web, film, foil or other flexible material that is not a process tape and which can be discarded or regenerated for future use.

As used herein, the term “conductive” refers to electrical conductivity. For example, a conductive material refers to any material capable of conducting an electrical current.

The present teaching relates a heating system and a method for heating a web in a roll-to-roll deposition system. By way of non-limiting examples, the deposition system can be based on reactive gas phase processing of web substrates, such as CVD, metal organic chemical vapor deposition (MOCVD) and halide vapor phase epitaxy (HYPE). The heating system includes a sacrificial tape comprising a material that adheres to a deposition material and a tape transport system to transport the sacrificial tape along a sacrificial tape path that passes through a deposition zone. In some embodiments, one or more heating elements are disposed near the sacrificial tape path and separated by a susceptor plate. In other embodiments, the sacrificial tape is electrically-conductive and a pair of conductive coupling elements are in contact with the sacrificial tape at respective positions along the sacrificial tape path. An electrical power source in communication with the coupling elements provides an electrical current through the sacrificial tape between the coupling elements to increase a temperature of the sacrificial tape. A process tape transported along a process tape path that is near to the sacrificial tape path is heated by the sacrificial tape.

Advantageously, in some embodiments the sacrificial tape serves to protect heating elements within the deposition zone from accumulations of deposited material. In addition, for alternative embodiments in which the tape is heated by electrical current, the need for discrete heating elements and a susceptor plate are eliminated.

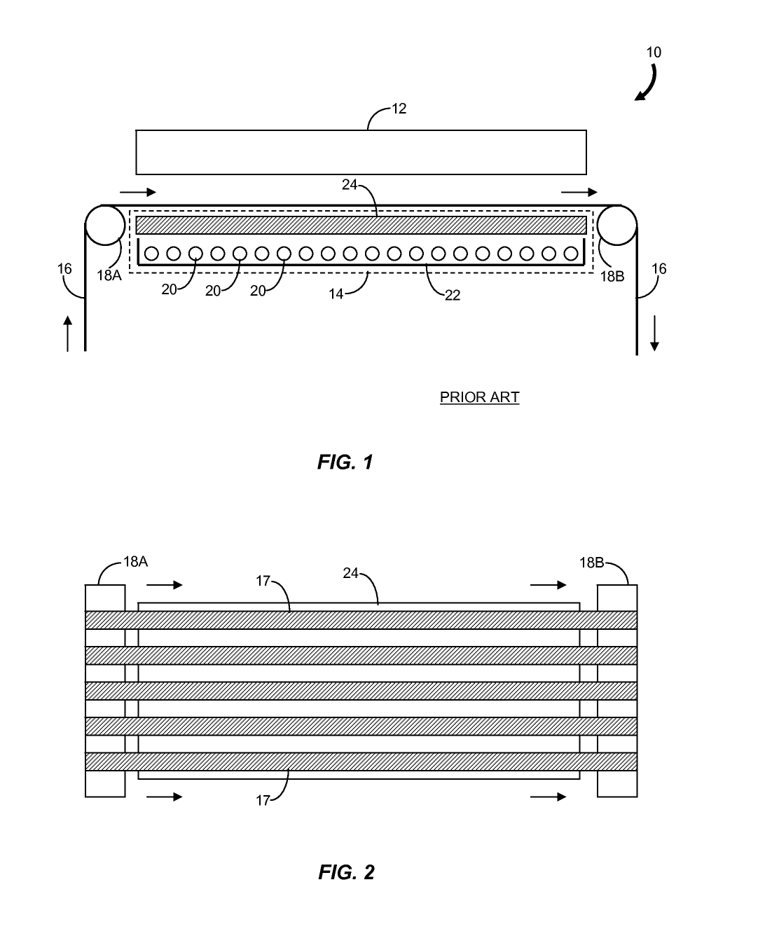

FIG. 1 illustrates a roll-to-roll deposition system 10 constructed according to a conventional architecture. The deposition system 10 includes a deposition head 12, a tape transport system (not shown) and a heating system 14 disposed within a deposition zone defined generally between the deposition head 12 and the heating system 14. The deposition head 12 can be configured in a variety of ways. For example, the deposition head 12 may include one or more sputtering guns, chemical vapor deposition (CVD) shower heads or other deposition sources.

The tape transport system includes a mechanism to move a process tape 16 from a payout roll (not shown), through the deposition zone and onto a takeup roll (not shown). A pair of rollers 18 is arranged to guide the tape 16 along a process tape path that passes between the deposition head 12 and the heating system 14. One or more guide rollers may be provided between the payout roll and the pair of rollers 18, and between the takeup roll and the pair of rollers 18. The tape transport system may also include one or more tensioners to maintain a substantially constant tension on the tape 16. After passing over any one or more guide rollers, the tape 16 from the payout roll passes over a portion of the surface of the first roller 18A then along the process tape path under the deposition head 12 before passing over a portion of the surface of the second roller 18B. The tape 16 leaving the second roller 18B may pass over one or more additional guide rollers before being wound onto the takeup roll.

The heating system 14 resides in the deposition zone on the opposite side of the process tape path from the deposition head 12. As illustrated, the heating system 14 includes heating elements 20 arranged between the rollers 18 and along one side of the process tape path within the deposition zone. By way of examples, the radiant heating elements 20 can be quartz lamps, molybdenum wires, tungsten wires, graphite elements and silicon carbide elements. A heat reflector 22 is located near the heating elements 20 to redirect radiant heating energy back toward the process tape path for more efficient heating. For example, the heat reflector 22 may include a metal or other substrate structure having one or more coating layers, such as a gold or silver layer, to provide a high reflectivity to the radiant energy emitted by the heating elements 20.

The heating system 14 also includes a susceptor plate 24 that is located between the heating elements 20 and the process tape path. The susceptor plate 24 separates the heating elements 20 from the deposition zone so that the heating elements 20 are not harmed by deposited material. By way of examples, the susceptor plate 24 may have a thickness in a range from 0.25 in. to 0.50 in. and can be constructed of stainless steel, Inconel®, silicon carbide or graphite. The susceptor plate 24 is heated by the heating elements 20 and in turn provides a uniform heating zone to the process tape 16 along a portion of the process tape path.

In various applications, the process tape 16 is heated to a temperature that can be in a range from less than 200° C. to more than 1,000° C. No significant material deposits accumulate on the susceptor plate 24 if the tape 16 is a continuous sheet of material that shields the entire susceptor plate 24. In contrast, if the tape 16 does not fully shield the susceptor plate 24, one or more regions on the susceptor plate 24 are exposed and receive an accumulation of the deposition material. FIG. 2 is a top down view from underneath the deposition head 12 for an example in which parallel narrow strips of tape 17 leave portions of the susceptor plate 24 exposed to the deposition material.

Accumulated material deposits can change the emissivity of the susceptor plate 24. As a result, the temperature of the susceptor plate 24 can change even though the power applied to the heating elements 20 is held constant. The temperature at one or more locations on or near the susceptor plate 24 can be monitored to enable a temperature control system to stabilize the temperature in the deposition zone. For example, the temperature may be monitored using at least one thermocouple positioned near the surface of the susceptor plate 24. Alternatively, an optical pyrometer can directly monitor the temperature of the process tape 16.

Deposits that accumulate on the susceptor plate 24 can lead to additional problems. Frequent maintenance may be required to remove the buildup of deposited material so that the material does not accumulate to a thickness at which the deposited material can crack. Flakes and particles released from the accumulated deposits during cracking can adversely affect the quality of the film deposited on the process tape 17.

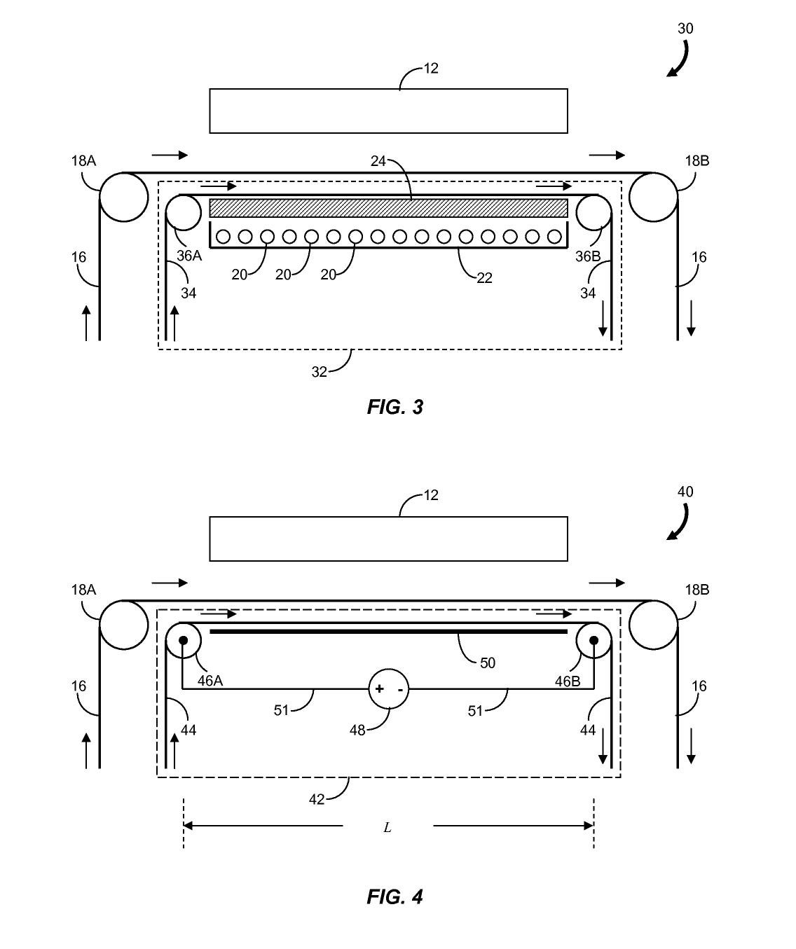

FIG. 3 illustrates a roll-to-roll tape deposition system 30 that includes a heating system 32 according to an embodiment of the invention. The deposition system 30 includes components similar to those shown and described above for the roll-to-roll deposition system 10 of FIG. 1; however, the heating system 32 is significantly different. In particular, the heating system 32 includes a sacrificial tape 34 and a pair of tape guides 36 to guide the sacrificial tape 34 along a sacrificial tape path that lies between the process tape path and the susceptor plate 24. In the illustrated embodiment, the tape guides 36 are a pair of rollers. A payout roll supplies the sacrificial tape 34 to the first roller 36A and a takeup roll receives the sacrificial tape 34 after exiting from the deposition zone and passing over a surface of the second roller 36B. The sacrificial tape material can be any material that has suitable adhesion for the deposition material and which can be heated to a sufficiently high temperature within the deposition zone to allow the nearby process tape 16 to be heated to the desired process temperature.

During operation, the sacrificial tape 34 is heated as it passes above the susceptor plate 24. In turn, the sacrificial tape 34 radiates heat such that the process tape 16 is heated during passage between the sacrificial tape 34 and the deposition head 12. The transport speed of the process tape 16 and the transport speed of the sacrificial tape 34 can be different. The transport speed of the sacrificial tape 34 may be determined, at least in part, such that the sacrificial tape 34 within the deposition zone achieves a temperature sufficient for heating the process tape 16 to the desired process temperature. Preferably, the transport speed of the sacrificial tape 34 is slow enough to limit its consumption while being fast enough to prohibit deposition material from accumulating on its surface to a thickness that can adversely affect the quality of the deposited layer on the process tape 16.

FIG. 4 illustrates a roll-to-roll tape deposition system 40 that includes a heating system 42 according to one preferred embodiment of the invention. Unlike the deposition systems described above, the heating system 42 does not have discrete heating elements, a reflector and a susceptor plate. Instead, a sacrificial tape 44 is heated by passing an electrical current through at least the portion of the sacrificial tape 44 that is in the deposition zone. Thus the sacrificial tape 44 performs the roles of the susceptor plate and the discrete heating elements at the same time while being continuously replenished during the process run. Advantageously, material that accumulates onto the sacrificial tape 44 is removed from the deposition zone as the sacrificial tape 44 is wound onto a takeup roll while additional sacrificial tape free of any deposits is introduced into the deposition zone in a continuous manner.

The heating system 42 includes the sacrificial tape 44, a pair of coupling elements 46, an electrical power source 48, a heat reflector 50 and a tape transport system. The electrical power source 48 is electrically coupled to the coupling elements 46 by wires or cables 51. A closed loop electrical path enable an electrical current to pass from the power source 48 to one of the coupling elements 46, through the through the current conducting portion L of the sacrificial tape 44, to the other coupling element 46 and back to the power source 48.

The sacrificial tape 44 is formed from a material that can conduct an electrical current. The width and the current conducting portion L of the length of the sacrificial tape 44 are selected to achieve a substantially constant temperature for the process tape 16 within the deposition zone. The current density, resistivity and cross-sectional area of the sacrificial tape 44 are selected to achieve a desired sacrificial tape temperature that is sufficient to heat the process tape 16 to an appropriate process temperature. The conductive material is preferably selected for adhesion with one or more materials to be deposited onto the process tape 16. By way of non-limiting examples, the conductive material can be stainless steel, molybdenum, tungsten, Inconel® metal alloy, Hastelloy® metal alloy and nickel tungsten. The sacrificial tape 44 can be made from a variety of electrically conductive materials. In some embodiments, the thickness of the sacrificial tape 44 is in a range from 25 μm to 100 μm.

The particular choice of material varies according to the application. Molybdenum and tungsten are suitable for higher tape temperatures. In some embodiments, the conductive material is coated by a thin layer of an oxide to prevent adverse reactions or oxidation within the deposition zone and that provides adhesion for the deposited material. For example, the oxide thickness may be between 100 Å and 1,000 Å.

The tape transport system transports the sacrificial tape 44 along a sacrificial tape path that passes through the deposition zone. The tape transport system includes a payout roll and a take up roll to supply and receive the sacrificial tape 44, respectively. One or both of the payout and takeup rolls may be coupled to a motor or other rotation mechanism that maintains a constant tape transport speed. One or more tensioners may also be provided to maintain a substantially constant tension on the sacrificial tape 44 throughout the process run. The tape transport system establishes and maintains the transport speed of the sacrificial tape 44 according to requirements of the process run. For example, the tape transport system can increase or decrease the tape transport speed for different process runs and thereby reduce or increase, respectively, the thickness of deposited material that accumulates on the sacrificial tape 44. The sacrificial tape transport speed is preferably substantially less that the speed at which the process tape 16 passes through the deposition zone. By way of example, the transport speed of the sacrificial tape 44 may be less than 0.1 mm/s to more than 1.0 mm/s.

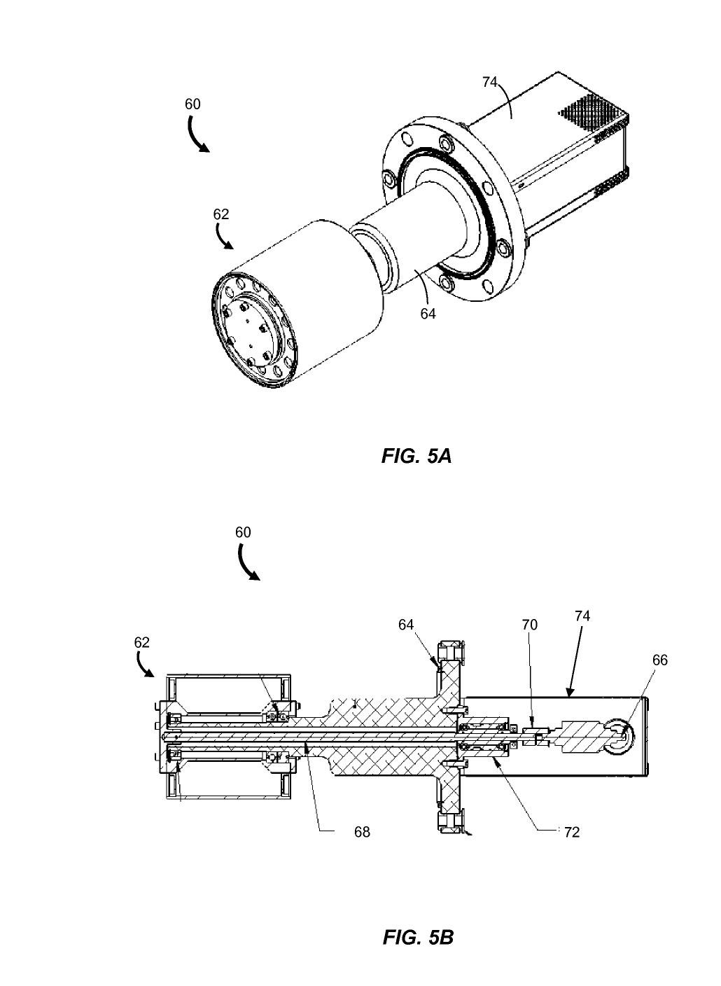

In some embodiments, the coupling elements 46 are conductive rollers. FIG. 5A and FIG. 5B are illustrations showing a perspective view and a cross-sectional view, respectively, of an assembly 60 that includes an electrically-conductive roller 62. Each conductive roller 62 is free to rotate about its cylindrical axis while maintaining electrical contact with the sacrificial tape passing over its cylindrical surface. In a preferred embodiment, the conductive roller 62 is formed of stainless steel.

The assembly 60 further includes a housing 64 that is configured for mounting to a wall or other structure which separates an ambient environment from the vacuum environment of the deposition system. An electrical slip ring 66, or other rotary electrical interface, provides a means for coupling the external electrical power source 48 to the conductive roller 62 via an intervening electrical path. The electrical path includes an electrically conductive shaft 68 preferably formed of stainless steel. The conductive shaft 68 is rotationally coupled at one end to the conductive roller 62 and rotationally coupled at the other end to the electrical slip ring 66 through a coupling element 70. A seal 72, such as a ferrofluidic feedthrough, is provided to seal the region where the conductive shaft 68 passes through the ambient to vacuum interface. The assembly also includes a housing 74 to protect the assembly components that reside outside of the vacuum environment.

Referring again to FIG. 4, the coupling elements 46 can also be in the form of tape guides or other structural features that provide an electrical contact with the passing sacrificial tape 44. For example, the coupling elements 46 can be electrically conductive rods or brushes that are in contact with a surface of the sacrificial tape 44.

The illustrated power source 48 is a direct current (DC) power source although in other embodiments an alternating current (AC) power source is used. The power source 48 provides the electrical current that heats the sacrificial tape 44. An electrical circuit is effectively formed so that current flows in a closed loop from the power source 48 through one conductive roller 46, through the sacrificial tape 44 in the region between the rollers 46, through the other conductive roller 46 and back to the power source 48. The applied voltage and current of the power source 48 are preferably determined by the thickness and width of the sacrificial tape 44 and the length of the sacrificial tape 44 between the coupling elements 46. By way of non-limiting numerical examples, the voltage can be in a range from 10 V to 100 V and the current can be in a range from 50 A to several hundred amperes. Preferably, at startup the supplied current is gradually increased, or ramped, to an operational value to limit thermal stress on the sacrificial tape 44. For example, the current may be gradually increased over several minutes until the desired sacrificial tape temperature is reached.

The power source voltage and current can be dynamically controlled to maintain the desired sacrificial tape temperature during a process run. During operation, the temperature of the sacrificial tape 44, the deposition zone and/or or the process tape 16 can be monitored and used to adjust the supplied current to thereby maintain a stable temperature for the entire process run.

By way of a non-limiting numerical example, the sacrificial tape 44 can be a nickel tungsten tape having a thickness of 75 μm and a width of 7.5 cm has a resistivity that ranges from 3.7×10-5 Ωcm at room temperature to 8.7×10-5 Ωcm at 800° C. A DC power source operating at 16 V and 230 A can achieve a sacrificial tape temperature between 800° C. and 900° C. for a length L of approximately 1 meter between the coupling elements 46. The temperature of the process tape 16 in the deposition zone is dependent in part on the process tape material and the efficiency of the heat reflector 50.

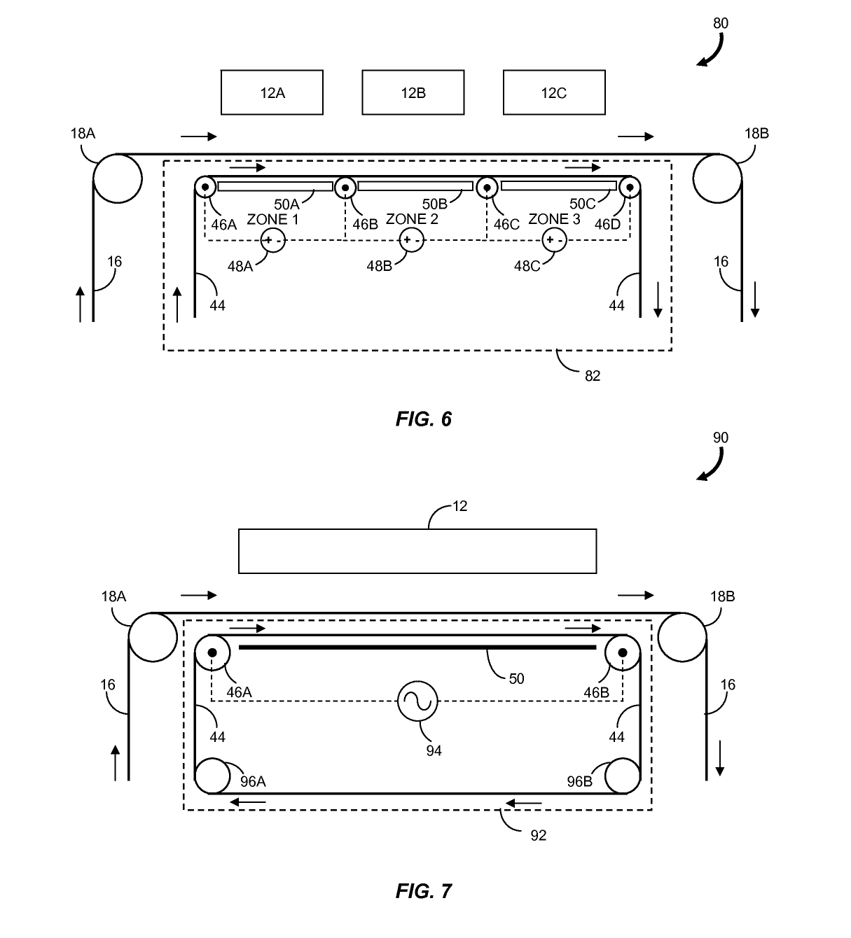

FIG. 6 shows a roll-to-roll deposition system 80 in which a heating system 82 according to another embodiment of the invention includes three heating zones. Each heating zone is associated with a corresponding deposition head 12 and deposition zone although it should be understood that in other embodiments two or more heating zones may be present in a single deposition zone. The electrical power sources 48 can be independently controlled so that the temperature of the sacrificial tape 44 within each heating zone is independently controllable. Thus the heating system 82 can accommodate more complex deposition processes such as multiple layer processes and gradient layer processes.

In some of the embodiments of heating systems for roll-to-roll deposition systems described above, the sacrificial tape with material deposits is wound onto a takeup roll. The sacrificial tape on the payout roll will be depleted after one or more process runs are completed, according to the amount of sacrificial tape originally supplied to the system, the sacrificial tape transport speed and other factors. The takeup roll may then be discarded and a new sacrificial tape loaded as a payout roll for subsequent process runs. Alternatively, the used sacrificial tape may be regenerated, for example, by using an etch bath or a mechanical scrubber such as a bead blaster to remove the accumulated deposition material. The regenerated sacrificial tape can then be loaded into the heating system as a payout roll and used for subsequent process runs.

FIG. 7 illustrates a roll-to-roll deposition system 90 having another embodiment of a heating system 92 in which the sacrificial tape 44 is configured in a continuous loop instead of using a payout roll and take up roll. An AC power source 94 is shown; however, it will be recognized that in alternative embodiments a DC power source can be used. The heating system 92 also includes a heat reflector 50, two conductive coupling elements 46 and two non-conducting tape guides 96 (e.g., non-conducting rollers). The conductive coupling elements 46 and non-conducting tape guides 96 define a sacrificial tape path for the loop of sacrificial tape 44. As illustrated, the sacrificial tape 44 is heated along the length extending between the two the two coupling elements 46.

In an alternative embodiment, the non-conducting tape guides are omitted and the continuous loop is defined simply by the two coupling elements 46. Consequently, current flows through both portions of the sacrificial tape 44 that extend between the coupling elements 46. Thus two separate lengths of the sacrificial tape 44 heated. In this alternative embodiment, the heating system can be used so that one length of the loop of sacrificial tape 44 is used to heat a first process zone while a second (opposite) length of the loop of sacrificial tape 44 is used to heat a second process zone. For example, the process tape path can be configured so that the process tape 16 passes near to one side of the loop and then near to the other side of the loop.

Advantageously, embodiments utilizing a continuous loop of sacrificial tape generally use small lengths of sacrificial tape and, in some implementations, avoid the need for tension control. The tape speed can be control so that the sacrificial tape makes multiple passes through the deposition zone or is limited to a single pass, according to the requirements of the particular process run. Embodiments of heating systems based in which the sacrificial tape is supplied from a payout roll may be preferred for process runs in which the accumulation of deposited material on the small length of a continuous loop would be sufficiently thick such that cracking may occur.

While the invention has been shown and described with reference to specific embodiments, it should be understood by those skilled in the art that various changes in form and detail may be made therein without departing from the spirit and scope of the invention as recited in the accompanying claims.

What is claimed is:

1. A heating system for a roll-to-roll tape deposition system, comprising:
a sacrificial tape comprising an electrically-conductive material;
a tape transport system to transport the sacrificial tape along a tape path;
a pair of coupling elements each comprising an electrically-conductive material and being in contact with the sacrificial tape at a position along the tape path; and
an electrical power source in electrical communication with the coupling elements,
wherein an electrical current flowing through the sacrificial tape between the coupling elements increases a temperature of the sacrificial tape.

2. The heating system of claim 1 further comprising a heat reflector disposed adjacent to at least a portion of the tape path between the coupling elements to redirect radiant heat back toward the sacrificial tape.

3. The heating system of claim 1 wherein each of the coupling elements is a roller having an electrically-conductive surface.

4. The heating system of claim 1 wherein each of the coupling elements has a rotary electrical feedthrough to couple the electrical current between a vacuum and an ambient environment.

5. The heating system of claim 1 wherein the tape transport system is controllable to vary a transport speed of the sacrificial tape.

6. The heating system of claim 1 wherein the conductive material comprises a material selected from a group consisting of stainless steel, molybdenum, tungsten, Inconel® metal alloy and nickel tungsten.

7. The heating system of claim 1 wherein the sacrificial tape comprises further comprises an oxide layer.

8. The heating system of claim 1 wherein the sacrificial tape is configured in a continuous loop.

9. The heating system of claim 1 further comprising a tensioning mechanism disposed along the tape path to dynamically adjust a tension of the sacrificial tape.

10. The heating system of claim 1 further comprising a temperature feedback system wherein a magnitude of an electrical current supplied by the electrical power source is responsive to a sensed temperature of the sacrificial tape.

11. A heating system for a roll-to-roll tape deposition system, comprising:
a sacrificial tape comprising a material that adheres to a deposition material;
a tape transport system comprising a pair of tape guides that define a sacrificial tape path through a deposition zone;
at least one heating element disposed along one side of the sacrificial tape path; and
a susceptor plate disposed between the at least one heating element and the one side of the sacrificial tape path.

12. The heating system of claim 11 wherein the pair of tape guides comprises a pair of rollers.

13. The heating system of claim 11 further comprising a heat reflector wherein the at least one heating element is disposed between the susceptor plate and the heat reflector and radiant heat from the at least one heating element is redirected by the heat reflector back toward the sacrificial tape in the deposition zone.

14. The heating system of claim 11 wherein the tape transport system is configured to vary a transport speed of the sacrificial tape.

15. The heating system of claim 11 wherein the sacrificial tape is configured in a continuous loop.

16. A roll-to-roll tape deposition system, comprising:
a deposition head configured to deposit a material on a process tape in a deposition zone;
a sacrificial tape comprising an electrically-conductive material;
a sacrificial tape transport system in mechanical engagement with the sacrificial tape and configured to transport the sacrificial tape along a tape path that passes through the deposition zone;
a pair of electrically-conductive rollers each being in contact with the sacrificial tape at a position along the sacrificial tape path wherein at least a portion of the sacrificial tape path between the electrically-conductive rollers is in the deposition zone;
an electrical power source in electrical communication with the coupling elements, wherein an electrical current flowing through the sacrificial tape between the coupling elements increases a temperature of the sacrificial tape; and
a process tape transport system to transport a process tape along a process tape path that passes through the deposition zone between the deposition head and the sacrificial tape path, wherein the sacrificial tape heats the process tape passing through the deposition zone.

17. A method for heating a process tape in a roll-to-roll deposition system, the method comprising:
transporting a sacrificial tape along a sacrificial tape path that passes through a deposition zone;
transporting a process tape along a process tape path that passes through the deposition zone, the process tape path within the deposition zone passing between a deposition head and the sacrificial tape path; and
conducting an electrical current through at least a portion of the sacrificial tape that is in the deposition zone to thereby heat the sacrificial tape, wherein the process tape in the deposition zone is heated by the sacrificial tape.

18. The method of claim 17 further comprising adjusting a magnitude of the electrical current in response to a sensed temperature in the deposition zone.

19. The method of claim 18 wherein the sensed temperature is a temperature of the process tape.

20. The method of claim 18 wherein the sensed temperature is a temperature of the sacrificial tape.
